(19) United States
(12) Patent Application Publication
(10) Pub. No.: US 2003/0078340 A1
(43) Pub. Date: Apr. 24, 2003

(54) Process for the preparation of additive coated molding powder

(76) Inventors: Anne Marie Fatnes, Stathelle (NO); Siw Fredriksen, Skien (NO); Astrid Frohaug, Stathelle (NO)

Correspondence Address: Nixon & Vanderhye, 8th Floor, 1100 North Glebe Road, Arlington, VA, 22201-4714, US

(21) Appl. No.: 10/204,276

(22) PCT Filed: Feb. 21, 2001
(86) PCT No.: PCT/GB01/00720

(51) Int. Cl. C08F 8/00

(52) U.S. Cl. 525/55

(57) ABSTRACT

A polyolefin polymer powder for use in rotational molding requires the presence of stabilizers, including UV-stabilizers, to prevent degradation during processing and use. It has been found that the polymer may be stabilized by a particular blend of additives or by the addition of a masterbatch of UV-stabilizer loaded polymer particles. Also, it has been found that polymer particles made using a supported catalyst manufactured using a mechanically fluidized bed, a product particularly suitable for rotomolding may be produced. Thus, the invention provides a process for the preparation of a polymer molding powder comprising (i) impregnating a mechanically fluidized porous particulate support material with a catalyst and polymerizing a monomer or monomer mixture in the presence of the catalyst-impregnated support material to give olefin polymer particles; and then either (ii) heating a mixture of: A) at least one phenolic antioxidant; B) at least one organic phosphite or phosphonite antioxidant; C) at least one UV-stabilizer; D) a diluent; and optionally E) a metal stearate; to a temperature of between 20 and 200° C.; (iii) depositing the mixture onto said polyolefin polymer particles; and optionally (iv) blending a metal stearate to the resulting polyolefin polymer particle if component E was not present in said mixture; or (iia) obtaining a second polymer; (iiia) intimately mixing said second polymer with a UV-stabilizer to produce a plurality of UV-stabilizer loaded polymer particles, e.g. by admixing stabilizer and particles of said second polymer followed by melting and grinding the resultant admixture; (iva) admixing polymer particles obtained in step (i) with UV-stabilizer-loaded polymer particles obtained in step (iiia).

This invention relates to a process for preparing an improved powder for rototational moulding, a process for the preparation of moulded polyolefin polymer products using such a powder, in particular to the moulding of a particulate polymer material by rotational moulding techniques and to the particulate polymer material and the moulded polymer products.

Rotational moulding is a polymer moulding technique which is particularly suitable for the production of large hollow polymer products, such as tanks, boxes, containers and other such items. It is quite different from other conventional moulding techniques such as injection moulding or blow moulding. A mould is charged with polymer powder, closed and placed in an oven where it is rotated so as to distribute the polymer powder over the mould surface. Once the polymer has melted and formed a coating on the mould surface the mould is cooled. Rotational moulding is described for example by Oliveira et al. in J. Materials Sci. 31: 2227-2240 (1996), Bawiskar et al in Polymer Engineering and Science 34: 815-820 (1994) and Bruins, “Basic Principles of Rotational Moulding”, Gordon and Breach, NY, 1971.

The polyolefin polymer powder used in rotational moulding, e.g. a polypropylene or more generally a polyethylene, requires the presence of stabilizers, including UV-stabilizers, to prevent degradation between the time the polymer is produced and when it is moulded. Stabilisers are also vital in preventing degradation during the rotomoulding process and in the eventual rotomoulded article. Addition of stabilisers is normally achieved by mixing polymer and stabilizers in an extruder mixer which applies shear force to mix the components and melt the polymer. The extrudate is then ground to produce a moulding powder of appropriate particle size. Such a procedure however is highly energy-consuming.

An alternative way of producing the stabilized moulding powder might thus have seemed to be to simply blend the stabilizers with an olefin polymer particulate which already has the appropriate particle size for rotational moulding, e.g. by spraying of liquid stabilizers or stabilizer solutions onto the polymer particulate and/or by simply mixing particulate stabilizers into the polymer particulate. This however has until now resulted in unacceptable deposits of the UV-stabilizer on the surface of the mould used in rotational moulding.

It has now been surprisingly found that a particular blend of additives may be employed in melt additivation without unacceptable deposits of the UV-stabilizer on the surface of the mould used in rotational moulding being formed. These blends must be very homogeneous and without wishing to be limited by theory, it is envisaged that the blends described below have greater solubility and compatibility with polymers such as polyethylene thus surprisingly allowing direct rotomoulding of the polymer powder without deposit formation.

It has also now been found that the moulding powder for rotational moulding may be sufficiently stabilized by simple mixing of a polyolefin polymer powder with a small quantity of a masterbatch of UV-stabilizer-loaded polymer particles. In this way polyolefin polymer particles as produced in a polymerization reactor may be used directly to produce the moulding powder without requiring energy-intensive extruder mixing and granulation and grinding of the entire material used to produce the moulding powder. Furthermore the problem of deposits of UV-stabilizer on the mould is reduced or avoided.

It has also been found that by synthesising the polymer particles using a supported catalyst manufactured using a mechanically created fluidised bed a product even more suitable for direct rotomoulding may be produced.

In the preparation of polymers, e.g. polyolefins and in particular polypropylenes and polyethylenes, it is conventional practice to use catalysts such as Ziegler Natta or metallocene catalysts. These, in particular the metallocene catalysts, may particularly effectively be used in supported form, i.e. where the catalyst has been impregnated into a porous, particulate inorganic or organic support material, e.g. an inorganic oxide such as silica, alumina, silica-alumina, or zirconia, an inorganic halide such as a magnesium chloride, or an organic polymer such as an acrylate or a styrene-divinylbenzene. The use of a support for the catalyst improves the handling characteristics of the polymer product and gives better control of reaction rates.

Such supported catalysts may be prepared by mixing the support (optionally after a heat treatment step) and a liquid containing the catalyst, using quantities of the liquid which are comparable to the pore volume of the support material such that catalyst waste is avoided. Using such small volumes of liquid, the formation of a mud or a slurry is avoided and in effect the mixing process is a dry-mixing process. While slurry mixing provides uniformity of loading of catalyst onto support which is superior to that achieved in conventional dry mixing, the volume of solvent used is significantly higher and this is environmentally undesirable. Moreover, with slurry mixing, the supported catalyst often has to be washed in order to avoid fouling in the polymerization reactor.

In general, the support and the catalysts are stirred during the impregnation step, e.g. using a magnetic stirrer or a helical stirrer.

The preparation of supported polymerization catalysts is described for example in NO-C-171858 (Neste), U.S. Pat. Nos. 5,559,071 (Hoechst), 5,625,015 (Exxon), WO95/11263 (Mobil), WO95/15216 (Borealis), WO95/12622 (Borealis), WO94/14855 (Mobil) and WO96/16093 (Exxon).

We have now found that the properties of such supported catalysts are improved if the mixing of catalyst and support is effected using mixing apparatus which creates a mechanically fluidized bed of the particulate support material in which catalyst impregnation may take place. This gives a much more homogeneous impregnation and results in a much more homogeneous powder morphology.

Many fluid bed devices are known—indeed at its simplest a fluid bed of a solid particulate material can be created by passing a continuous flow of gas through the particulate material. However by use of a mechanically created fluidized bed the loss of solvent during impregnation is avoided and gas generated fluid beds provide little if any mixing effect. By mechanically fluidized it is meant that bed fluidization is achieved at least partly through the use of agitation of the particles caused by a mechanical, ie. solid, apparatus, preferably a mixing apparatus, rather than solely by passage of a gas through the bed. Gas passage may be used in addition to mechanical agitation but, as mentioned above, this may be undesirable due to solvent loss.

Thus, viewed from one aspect the invention provides a process for the preparation of a polymer moulding powder comprising

(i) impregnating a mechanically fluidized porous particulate support material with a catalyst and polymerizing a monomer or monomer mixture in the presence of the catalyst-impregnated support material to give olefin polymer particles; and then either

(ii) heating a mixture of:

A) at least one phenolic antioxidant preferably selected from [Octadecyl 3-(3′,5′-di-tert.butyl-4-hydroxyphenyl)propionate] (e.g. Irganox 1076) or [Pentaerythrityl-tetrakis(3-(3′,5′-di-tert.butyl-4-hydroxyphenyl)-propionate] (e.g. Irganox 1010);

B) at least one organic phosphite or phosphonite antioxidant preferably selected from [Bis(2-methyl-4,6-bis(1,1-dimethylethyl)phenyl)phosphorous acid ethylester] (e.g. Irgafos 38), [Tris(2,4-di-t-butylphenyl)phosphite] (e.g. Irgafos 168), tris-nonylphenyl phosphate, [Tetrakis-(2,4-di-t-butylphenyl)-4,4′-biphenylen-di-phosphonite] (e.g. Irgafos P-EPQ) or [Phosphorous acid-cyclic butylethyl propandiol, 2,4,6-tri-t-butylphenyl ester] (e.g. Ultranox 641);

C) at least one UV-stabiliser preferably selected from [1,6-Hexanediamine, N,N′-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine] (e.g. Chimassorb 2020), [Poly((6-morpholino-s-triazine-2,4-diyl)(2,2,6,6-tetramethyl-4 piperidyl)imino)hexamethylene (2,2,6,6-tetramethyl-4-piperidyl)imino))] (e.g. Cyasorb UV 3346), [Poly((6-((1,1,3,3-tetramethylbutyl)amino)-1,3,5-triazine-2,4-diyl)(2,2,6,6-tetramethyl-4-piperidyl)imino)-1,6-hexanediyl((2,2,6,6-tetramethyl-4-piperidyl)imino))] (e.g. Chimassorb 944), Cyasorb 4042 or Cyasorb 4611;

D) a diluent; and optionally

E) a metal stearate;

preferably under an inert atmosphere, to a temperature of between 20 and 200° C.;

(iii) depositing the mixture onto said polyolefin polymer particles; and optionally

(iv) blending a metal stearate to the resulting polyolefin polymer particles if component E was not present in said mixture; or

(iia) obtaining a second polymer, preferably employing the same method as in part (i); (iiia) intimately mixing said second polymer with a UV-stabilizer to produce a plurality of UV-stabilizer loaded polymer particles, e.g. by admixing stabilizer and particles of said second polymer followed by melting and grinding the resultant admixture; (iva) admixing polymer particles obtained in step (i) with UV-stabilizer-loaded polymer particles obtained in step (iiia).

Viewed from another aspect the invention provides a polymer moulding powder for rotational moulding obtainable by a process as hereinbefore described.

Viewed from yet another aspect the invention provides a process for the preparation of a moulded polymer item, said process comprising rotomoulding a polymer moulding powder as hereinbefore described.

Viewed from a still further aspect the invention provides moulded polymer items obtainable by a process in which a polymer moulding powder of the invention is rotomoulded.

The combination of the polymerisation technique desribed in part (i) and either of the additivation techniques described in (ii) to (iv) or (iia) to (iva) is advantageous since the resulting moulding powder is very homogeneous and may be used directly in rotomoulding. The resulting rotomoulded articles have impact properties, colour and long term properties on the same level as previously achieved by pelletising and grinding the polymer before rotomoulding.

A comprehensive discussion of the materials and methods required to effect stage (i) above are disclosed in PCT/GB99/03355 which is herein incorporated by reference.

A comprehensive discussion of the materials and methods required to effect stage (iia) to (iva) above are disclosed in PCT/GB99/02733 which is herein incorporated by reference.

Mixing methods may be characterized by their Froude number (Fr) which is given by the equation

$$Fr = \frac{R {ω}^{2}}{g}$$

i.e. the ratio of centrifugal force to gravity. Mixers generally fall into the categories:

1. Froude number below 1 (e.g. thrust mixers and free fall mixers)

2. Froude number above 1 (e.g. fluid bed mixers)

3. Froude number considerably above 1 (e.g. centrifugal and intensive mixers).

The mixers used in stage 1 of the present invention will generally have a Froude number of 1.005 to 2.8, more preferably 1.05 to 2.2.

More particularly, the mixers used will preferably put at least 30% wt, more preferably at least 50% wt of the support material into a “weightless” condition when in operation (see for example Forberg, Mixing-powder handling and processing 4: 318 (September 1992)).

The support material used is conveniently an inorganic or organic material, e.g. an inorganic oxide such as silica, alumina, silica-alumina, zirconia, magnesia or titania, talc or an inorganic halide such as magnesium chloride, or a polymer such as an acrylate, methacrylate or styrene-divinylbenzene. Silica, alumina or titania or combinations thereof loaded with chromium compounds e.g. chromium oxides, may also advantageously be used as support materials.

Preferably the support material, if inorganic, is subjected to a heat treatment (calcination) before catalyst impregnation, e.g. by a period of heat treatment in a dry, non-reducing (e.g. oxygen containing) atmosphere such as air at a temperature of at least 200° C., preferably at least 400° C. and especially preferably at least 600° C., for a period of 0.5 to 50 hours, e.g. 2 to 30 hours, preferably 10 to 20 hours. The support material before calcination conveniently has a surface area of 20 to 1000 m²/g (BET method), e.g. 100 to 400 m²/g, a porosity of up to 5 mL/g, e.g. 0.2 to 3.5 mL/g and a mean particle size of 3 to 250 μm, especially 5 to 200 μm, preferably 5 to 100 μm, e.g. 5 to 50 μm, in particular 10 to 40 μm. The average pore diameter in the support is preferably 10 to 1000 Å, e.g. 50 to 900 Å, more preferably 40 to 350 Å. Examples of suitable support materials include Sylopol 2109 (a silica available from Grace Davison with an average particle size of 20 μm and a pore volume of 1.5-2.0 mL/g), ES70F (a silica available from Crosfield with an average particle size of 14 μm and a surface area of 281 m²/g) and MD 747JR (a silica available from Crosfield with an average particle size of 20 μm). SP9-275, Davison 955, Davison 948, XP02408, SP9-10150, SP9-10156 Sylopol 5550, XP02403, Sylopol 55SJ, SP9-10180, and Sylopol 2104 silicas from Grace Davison, ES70 and ES70X silicas from Crosfield, and CS2133, CS2040, MS3040, MS3040F, SP2-7877, MS3040A and MS1733 silicas from PQ Corporation may also be used. Examples of suitable polymer supports include porous polypropylene and polyethylene available from Accurel or Akzo Nobel, and monodisperse polymethacrylates and polystyrenes available from Dyno Speciality Polymers, Lillestrøm, Norway.

Alternatively, the support material may be dehydrated chemically by reaction of surface hydroxyl groups with chemical agents such as for example chlorosilanes and aluminium alkyls. By way of example see EP-A-507876, EP-A-670336, EP-A-670325 and “The Chemistry of Silica”, Chapter 6, R. K. Iler, Wiley, 1979.

The catalyst with which the support material is impregnated may be any polymerization catalyst or combination of two or more catalysts, optionally together with one or more co-catalysts or catalyst activators. Where two or more components, e.g. catalysts and co-catalysts, are used, these can be loaded onto the support sequentially or simultaneously. Preferably the catalyst is a Ziegler Natta catalyst (i.e. the combination of a transition metal (e.g. Ti, V or Cr) compound and an aluminium compound), a pyrazolyl catalyst (e.g. as described in WO97/17379, U.S. Pat. No. 4,808,680, EP-A-482934, U.S. Pat. No. 5,312,394 or EP-A-617052) or an η-liganded metal catalyst, e.g. a metallocene catalyst. Such catalysts will generally be applied to the support in solution in a labile organic solvent, e.g. an aromatic solvent such as toluene, an aliphatic hydrocarbon solvent such as heptane or a halogenated aliphatic hydrocarbon such as methylene chloride or chloroform. Toluene is generally preferred.

Examples of suitable catalysts and co-catalysts are known from EP-A-206794, EP-A-22595, EP-A-129368, EP-A-520732, EP-A-561476, EP-A-279586, EP-A-420436, EP-A-347128, EP-A-551277, EP-A-648230, WO 94/03506, WO 96/28479, U.S. Pat. No. 5,057,475, EP-A-672688, EP-A-368644, EP-A-491842, EP-A-614468, EP-A-705281, WO 92/00333, WO 94/07928, WO 91/04257, WO 93/08221, WO 93/08199, WO 94/10180, U.S. Pat. Nos. 5,096,867, 5,055,438, 5,198,401, 5,264,405, 5,227,440, 4,530,914, 4,952,716, 5,127,418, 4,808,561, 4,897,455, 5,278,119, 5,304,614, 4,665,208, 4,952,540, 5,091,352, 5,206,199, 5,204,419, 4,874,734, 4,924,018, 4,908,463, 4,968,827, 5,308,815, 5,248,801, 5,235,081, 5,157,137, 5,103,031, 5,064,802, 5,149,819, 5,243,001, 5,239,022, 5,276,208, 5,296,434, 5,321,106, 5,304,614, WO 93/19103, WO 95/07939, WO 97/29134, WO 98/02470, WO 95/12622, U.S. Pat. Nos. 5,086,135, 5,455,214, WO 97/32707, EP-A-519237, EP-A-518092, EP-A-444474, EP-A-416815, EP-A-62979, EP-A-284708, EP-A-354893, EP-A-567952, EP-A-594218 and EP-A-661300.

For metallocene-based catalysts, the catalytically effective metal is preferably a transition metal or a lanthanide, especially a group 4, 5 or 6 metal, e.g. Ti, Zr or Hf. Such metallocenes include a η-bonding ligand, e.g. an optionally substituted optionally fused homo or heterocyclic cyclopentadienyl ligand, preferably with 1, 2 or 3 η-bonding groups coordinating the metal (the term metallocene is often used to denote complexes in which a metal is coordinated by η-bonding groups—here, however, it is used in its broader sense to cover complexes in which the metal is coordinated by one or more η-bonding groups, i.e. groups which use their π-oribtals to complex the metal). Examples of such η-bonding ligands include cyclopentadienyl, indenyl, tetrahydroindenyl, fluorenyl and octahydrofluorenyl ligands and bridged dimers where such η-ligands are attached, e.g. via a 1, 2, 3 or 4 atom chain (e.g. containing C, N, O, S, Si or P chain atoms—for example an ethylene or Si(CH₃)₂ group), to a further such η-ligand.

Thus by way of example the metallocene catalyst may be of formula I

(CpR′ₖ)ₘMRₙX_{q} (I)

where Cp is a fused or non fused homo or heterocyclic cyclopentadienyl η-ligand;

R′ is a hydrocarbyl, hydrocarbyloxy, hydrocarbylsilyloxy or hydrocarbylgermyloxy group containing 1 to 20 carbon atoms or one R′ is a bridging group to a further fused or non fused homo or heterocyclic cyclopentadienyl η-ligand, the bridging group preferably providing a 1, 2, 3 or 4 atom chain between the cyclic groups, for example with C, N, O, S, P or Si chain atoms, especially C and/or Si, e.g. an ethylene group;

k is zero or an integer having a value of 1, 2, 3, 4 or 5;

M is a group 4, 5 or 6 metal;

X is a halogen atom;

R is hydrogen or a hydrocarbyl or hydrocarbyloxy group containing 1 to 20 carbon atoms;

m is the integer 1, 2 or 3;

n and q are zero or integers 1, 2 or 3; and

the sum of m, n and q corresponds to the degree of coordination possible for M in the oxidation state in which it exists.

Preferably the metallocene contains at least one Cp group other than unsubstituted cyclopentadienyl, i.e. preferably the metallocene is a “substituted metallocene”.

Particularly preferably the metallocene is a bridged bis-indenyl metallocene.

Many metallocene catalysts are known, e.g. as described in the patent publications mentioned above and the patent publications of Exxon, Mobil, BASF, DOW, Targor, Fina, Hoechst and Borealis, e.g. EP-A-206749, EP-A-413326, EP-A-129368, WO99/40129 etc.

Typical examples of ligands suitable for metallocenes include the following:

cyclopentadienyl, indenyl, fluorenyl, pentamethyl-cyclobutadienyl, methyl-cyclopentadienyl, 1,3-di-methyl-cyclopentadienyl, i-propyl-cyclopentadienyl, 1,3-di-i-propyl-cyclopentadienyl, n-butyl-cyclopentadienyl, 1,3-di-n-butyl-cyclopentadienyl, t-butyl-cyclopentadienyl, 1,3-di-t-butyl-cyclopentadienyl, trimethylsilyl-cyclopentadienyl, 1,3-di-trimethylsilyl-cyclopentadienyl, benzyl-cyclopentadienyl, 1,3-di-benzyl-cyclopentadienyl, phenyl-cyclopentadienyl, 1,3-di-phenyl-cyclopentadienyl, naphthyl-cyclopentadienyl, 1,3-di-naphthyl-cyclopentadienyl, 1-methyl-indenyl, 1,3,4-tri-methyl-cyclopentadienyl, 1-i-propyl-indenyl, 1,3,4-tri-i-propyl-cyclopentadienyl, 1-n-butyl-indenyl, 1,3,4-tri-n-butyl-cyclopentadienyl, 1-t-butyl-indenyl, 1,3,4-tri-t-butyl-cyclopentadienyl, 1-trimethylsilyl-indenyl, 1,3,4-tri-trimethylsilyl-cyclopentadienyl, 1-benzyl-indenyl, 1,3,4-tri-benzyl-cyclopentadienyl, 1-phenyl-indenyl, 1,3,4-tri-phenyl-cyclopentadienyl, 1-naphthyl-indenyl, 1,3,4-tri-naphthyl-cyclopentadienyl, 1,4-di-methyl-indenyl, 1,4-di-i-propyl-indenyl, 1,4-di-n-butyl-indenyl, 1,4-di-t-butyl-indenyl, 1,4-di-trimethylsilyl-indenyl, 1,4-di-benzyl-indenyl, 1,4-di-phenyl-indenyl, 1,4-di-naphthyl-indenyl, methyl-fluorenyl, i-propyl-fluorenyl, n-butyl-fluorenyl, t-butyl-fluorenyl, trimethylsilyl-fluorenyl, benzyl-fluorenyl, phenyl-fluorenyl, naphthyl-fluorenyl, 5,8-di-methyl-fluorenyl, 5,8-di-i-propyl-fluorenyl, 5,8-di-n-butyl-fluorenyl, 5,8-di-t-butyl-fluorenyl, 5,8-di-trimethylsilyl-fluorenyl, 5,8-di-benzyl-fluorenyl, 5,8-di-phenyl-fluorenyl and 5,8-di-naphthyl-fluorenyl.

Examples of particular metallocenes are listed on pages 10 to 35 of WO99/40129, the contents of which are hereby incorporated by reference.

Thus examples of particular metallocenes include dimethylsilandiylbis(indenyl)zirconiumdichloride, dimethylsilandiylbis(4-naphthyl-indenyl)zirconiumdichloride, dimethylsilandiylbis(2-methyl-benzo-indenyl)zirconiumdichloride, dimethylsilandiylbis(2-methyl-indenyl)zirconiumdichloride, dimethylsilandiylbis(2-methyl-4-(1-naphthyl)-indenyl)zirconiumdichloride, dimethylsilandiylbis(2-methyl-4-(2-naphthyl)-indenyl)zirconiumdichloride, dimethylsilandiylbis(2-methyl-4-phenyl-indenyl)zirconiumdichloride, dimethylsilandiylbis(2-methyl-4-t-butyl-indenyl)zirconiumdichloride, dimethyl-silandiylbis(2-methyl-4-isopropyl-indenyl)zirconium-dichloride, dimethylsilandiylbis(2-methyl-4-ethyl-indenyl)zirconiumdichloride, dimethylsilandiylbis(2-methyl-4-acenaphth-indenyl)zirconiumdichloride, dimethylsilandiylbis(2,4-dimethyl-indenyl)-zirconiumdichloride, dimethylsilandiylbis(2-ethyl-indenyl)zirconiumdichloride, dimethylsilandiylbis(2-ethyl-4-ethyl-indenyl)zirconiumdichloride, dimethylsilandiyl-bis(2-ethyl-4-phenyl-indenyl)zirconiumdichloride, dimethylsilandiylbis(2-methyl-4,5-benzo-indenyl)zirconiumdichloride, dimethylsilandiylbis(2-methyl-4,6 diisopropyl-indenyl)zirconiumdichloride, dimethyl-silandiylbis(2-methyl-4,5 diisopropyl-indenyl)zirconium-dichloride, dimethylsilandiylbis-(2,4,6-trimethyl-indenyl)zirconiumdichloride, dimethylsilandiylbis(2,5,6-trimethyl-indenyl)zirconium-dichloride, dimethyl-silandiylbis(2,4,7-trimethyl-indenyl)zirconiumdichloride, dimethylsilandiylbis(2-methyl-5-isobutyl-indenyl)zirconiumdichloride, dimethylsilandiylbis(2-methyl-5-t-butyl-indenyl)zirconium-dichloride, methyl(phenyl)silandiylbis(2-methyl-4-phenyl-indenyl)zirconiumdichloride, methyl(phenyl)silandiylbis(2-methyl-4,6 diisopropyl-indenyl)zirconiumdichloride, methyl(phenyl)silandiylbis(2-methyl-4-isopropyl-indenyl)zirconiumdichloride, methyl(phenyl)-silandiylbis-(2-methyl-4,5-benzo-indenyl)zirconiumdichloride, methyl(phenyl)silandiylbis (2-methyl-4,5-(methylbenzo)-indenyl)zirconiumdichloride, methyl(phenyl)silandiylbis-(2-methyl-4,5-(tetramethylbenzo)-indenyl)zirconiumdichloride, methyl(phenyl)silandiylbis(2-methyl-4-acenaphth-indenyl)zirconiumdichloride, methyl(phenyl)-silandiylbis(2-methyl-indenyl)zirconiumdichloride, methyl(phenyl)silandiylbis(2-methyl-5-isobutyl-indenyl)-zirconiumdichloride, 1,2-ethandiylbis(2-methyl-4-phenyl-indenyl)zirconiumdichloride, 1,4-butandiylbis(2-methyl-4-phenyl-indenyl)zirconium-dichloride, 1,2-ethandiylbis-(2-methyl-4,6 diisopropyl-indenyl)zirconiumdichloride, 1,4-butandiylbis(2-methyl-4-isopropyl-indenyl)zirconium-dichloride, 1,4-butandiylbis(2-methyl-4,5-benzo-indenyl)zirconiumdichloride, 1,2-ethandiylbis(2-methyl-4,5-benzo-indenyl)zirconiumdichloride, 1,2-ethandiylbis(2,4,7-trimethyl-indenyl)zirconiumdichloride, 1,2-ethandiylbis(2-methyl-indenyl)zirconiumdichloride, 1,4-butandiylbis(2-methyl-indenyl)zirconiumdichloride, [4-(0⁵-cyclopentadienyl)-4,6,6-trimethyl-(0⁵-4,5-tetrahydropentalen)]-dichloro-zirconium, dimethyl-silandiylbis(2-methyl-4-(4′-tert-butyl-phenyl)-indenyl)zirconiumdichloride, dimethyl-silandiylbis(2-methyl-4-(4′-methyl-phenyl)-indenyl)-zirconiumdichloride, dimethylsilandiylbis(2-methyl-4-(4′-ethyl-phenyl)-indenyl)zirconiumdichloride, dimethylsilandiylbis(2-methyl-4-(4′-trifluormethyl-phenyl)-indenyl)zirconiumdichloride, dimethylsilandiyl-bis(2-methyl-4-(4′-methoxy-phenyl)-indenyl)zirconiumdichloride, dimethylsilandiylbis(2-ethyl-4-(4′-tert-butyl-phenyl)-indenyl)zirconiumdichloride, dimethylsilandiylbis(2-ethyl-4-(4′-methyl-phenyl)-indenyl)-zirconiumdichloride, dimethylsilandiylbis(2-ethyl-4-(4′-ethyl-phenyl)-indenyl)zirconiumdichloride, dimethylsilandiylbis(2-ethyl-4-(4′-trifluormethyl-phenyl)-indenyl)-zirconium-dichloride, and dimethylsilandiylbis(2-ethyl-4-(4′-methoxy-phenyl)-indenyl)zirconiumdichloride.

Further examples include bis(trimethylsilyl)silanediyldicyclopentadienylzirconium dichloride, bis(trimethylsilyl)silanediyldiindenylzirconium dichloride, bis(trimethylsilyl)silanediylbis(2-methyl-indenylzirconium dichloride, bis(trimethylsilyl)silanediylbis(2-methyl-4,5-benzoindenyl)zirconium dichloride, bis(trimethylsilyl)silanediylbis(2-methyl-4-phenyl-indenyl)zirconium dichloride, bis(trimethylsilyl)silanediylbis(2-methyl-4-naphthylindenyl)zirconium dichloride, bis(trimethylsilyl)silanediyldifluorenylzirconium dichloride, bis(trimethylsilyl)silanediyl(fluorenyl)-(cyclopentadienyl)zirconium dichloride, bis(trimethylsilyl)silanediyl(fluorenyl)(indenyl)zirconium dichloride, bis (trimethylsilyl)silanediyl(tetramethyl-cyclopentadienyl)(indenyl)zirconium dichloride, methyl(trimethylsilyl)silanediyldicyclopentadienylzirconium dichloride, methyl(trimethylsilyl)silanediyldiindenylzirconium dichloride, methyl(trimethylsilyl)-silanediylbis(2-methylindenyl)zirconium dichloride, methyl(trimethylsilyl)silanediylbis(2-methyl-4,5-benzoindenyl)zirconium dichloride, methyl(trimethylsilyl)silanediylbis(2-methyl-4-phenylindenyl)zirconium dichloride, methyl(trimethylsilyl)silanediylbis(2-methyl-4-naphthylindenyl)zirconium dichloride, methyl(trimethylsilyl)silanediyldifluorenylzirconium dichloride, methyl(trimethylsilyl)silanediyl(fluorenyl)-(cyclopentadienyl)zirconium dichloride, methyl-(trimethylsilyl)silanediyl(fluorenyl)(indenyl)zirconium dichloride and methyl(trimethylsilyl)silanediyl(tetra-methylcyclopentadienyl)(indenyl)zirconium dichloride, and the dimethylsilanediyl analogs thereof.

The catalysts may require the use of a co-catalyst or catalyst activator. Preferred as co-catalysts are the aluminoxanes, in particular the C₁₋₁₀ alkyl aluminoxanes and most particularly methyl aluminoxane (MAO).

Such aluminoxanes may be used as the sole co-catalyst or alternatively may be used together with other co-catalysts. Thus besides or in addition to aluminoxanes, other cation complex forming catalyst activators may be used. In this regard mention may be made of the silver and boron compounds known in the art. What is required of such activators is that they should react with the metallocene or pyrazolyl complex to yield an organometallic cation and a non-coordinating anion (see for example the discussion on non-coordinating anions J⁻ in EP-A-617052 (Asahi)).

Aluminoxane co-catalysts are described by Hoechst in WO94/28034. These are linear or cyclic oligomers having up to 40, preferably 3 to 20, —[Al(R″)O]— repeat units (where R″ is hydrogen, C₁₋₁₀ alkyl (preferably methyl) or C₆₋₁₈ aryl or mixtures thereof).

Where a co-catalyst is used, it may be used separately but more preferably it is also loaded onto the porous support material. In this event it is preferred to allow the catalyst and the co-catalyst to react in a liquid phase and to load the reaction product onto the support.

The support impregnation is preferably effected by contacting the fluidized support with the catalyst and/or co-catalyst in a liquid, or less preferably a gaseous form, e.g. in solution in an organic solvent. The volume of liquid used is preferably 0.5 to 2.0, more preferably 0.8 to 1.5, especially 0.9 to 1.25, more especially 1.01 to 1.20, for example 0.9 to 1.1, times the pore volume of the support material. Most preferably the volume of liquid is such that an essentially dry mixing occurs, i.e. it is preferred to use a quantity insufficient to form a mud or a slurry with the support material.

Impregnation of the support material is especially preferably achieved by spraying the catalyst and/or co-catalyst liquid or solution onto the mechanically fluidized bed in the mixing apparatus. The portion of the support material bed which is mechanically fluidized may be a large or small part of the overall bed; desirably however at least 30%, more particularly at least 50%, of the bed is in fludized form when the mechanical agitators in the mixer are in motion.

The liquid or solution is preferably directed substantially only (e.g. at least 90%) onto the mechanically fluidized surface and preferably it is directed onto at least 50% of the fluidized surfaces. Any appropriate spray geometry may be used; however the spray rate is desirably substantially uniform over the surface area sprayed. Spraying may be continuous, intermittent or batchwise and if desired spray rate may be varied continuously or intermittently. Spraying may involve application of a fine liquid stream and/or production of droplets, e.g. of 1 μm to 2 mm diameter, preferably a diameter beneath that of the support material particle size, e.g. 1 to 60%, more preferably 5 to 40% of particle size. The spray may be applied using any appropriate means, e.g. nozzles, sprinklers, atomizers, deflectors, etc. The solution may also be added simply by means of a dip tube.

Several forms of mechanical agitation of the particulate support material may be used to produce a mechanically fluidized material; however it is particularly effective to use horizontal axis, counter-rotating, interlocking mixing paddles, i.e. where paddles on different but preferably parallel rotational axes pass through a common mixing zone. Such fluidized bed mixing apparatus are available from: H. Forberg A S, Norway; H. R. Gericke Ltd., Switzerland (e.g. Gericke Multi-Flux Mixers and Twin-Shaft Mixers); and IdeCon, Norway. The Forberg mixer is illustrated schematically in FIG. 1 of the accompanying drawings.

Such mixers may if desired be fitted with temperature control devices, e.g. heating or cooling jackets. Likewise, the mixing chamber may be fitted with pressure control devices, e.g. pressure or vacuum pumps, so that the pressure within the mixing chamber may be controlled to a desired atmospheric, sub-atmospheric or elevated pressure during supported catalyst preparation or pre-polymerization (see for example WO 96/18661).

The mixer apparatus may be used in batchwise or continuous operation. Continuous operation mechanically fluidized fluid bed mixers are available for example from IdeCon, Porsgrunn, Norway.

Following impregnation with the catalyst and/or co-catalyst, the support can if desired be dried, e.g. to a residual solvent content of less than 3% wt. This is preferably performed using a heated gas flow (e.g. at 40 to 200° C., preferably at 65 to 120° C., especially about 100° C.) and especially preferably is effected while the support is maintained in fluidized state in a fluid bed mixer, e.g the same mixer as used for catalyst impregnation. The heated gas is preferably a non-reactive gas, e.g. nitrogen or a noble gas such as argon. The use of nitrogen is preferred. Heat transfer in the fluidized zone is very efficient and even on a commercial scale drying may be effected within a relatively short period, e.g. 1 to 15 hours, particularly 3 to 10 hours. Drying however can be effected or accelerated by other heating means, e.g. heating jackets as mentioned above or microwave heating. For microwave heating, a microwave antenna may be immersed in the bed to ensure direct contact and high efficiency (see for example WO 96/34224).

The supported catalyst may be modified further while still in the mixing apparatus (or alternatively following removal from the mixing apparatus). Such modification may include pre-polymerization (as described further below) or addition of for example antistatic or wetting agents. Examples of antistatic agents are discussed in U.S. Pat. No. 5,283,278. Likewise the support material may be chemically or physically treated while in the mixing apparatus before the catalyst solution is applied or alternatively before or during loading into the mixing apparatus. Such treatment may include for example heat treatment (as discussed earlier), treatment to chemically modify the support surface, treatment to introduce catalytically active sites onto the support material particles, impregnation with co-catalysts on catalyst activators, etc.

Where catalyst impregnation of support has involved the use of solvents, e.g. organic or more particularly hydrocarbon solvents such as toluene, it is especially advantageous that the catalyst—and/or catalyst/cocatalyst—impregnated support should be dried so as to reduce the solvent content to a very low level. In particular it has surprisingly been found that there is a substantial increase in catalyst activity and performance when the impregnated support is dried such that the organic solvent content is reduced to below 1.5% wt, preferably below 1% wt, more preferably to below 0.7% wt.

In conventional post-impregnation methods of drying supported catalysts (e.g heating, vacuum, gas treatment and combinations thereof), the residual solvent content is brought down from 10-70% wt to 2-10% wt, or 2-5% wt and the supported catalyst is then packaged, ready-for-use. Between 2 and 10% wt solvent residue, the value of percentage solvent residue does not affect catalyst performance.

Such superdrying of supported catalysts, in particular supported metallocene/aluminoxane catalysts, has been observed to increase catalyst activity by as much as 50 to 100%. This increase can be used to reduce total quantities of catalyst used per ton polymer produced, e.g. by use of less supported catalyst or by use of lower concentration levels of catalyst during support impregnation.

The superdrying moreover results in reduced leakage of catalyst materials from the impregnated supports. This in turn may reduce the risk of reactor fouling and the sheeting and chunking in gas phase reactors, and may result in improved polymer morphology.

Reductions in forms of reactor fouling are particularly important as this means reductions in reactor down time, a factor of critical importance in large scale commercial processes.

The supported catalysts can be dried to such super-dried states using conventional procedures but longer than conventional drying times or more extreme drying conditions. Thus such residual moisture contents can be simply achieved by gentle warming with heated nitrogen while being stirred and mixed. However the drying of the impregnated support is preferably carried out in a fluid bed apparatus, e.g. a gas-fluidized bed or, more preferably, a mechanically fluidized bed. The drying effect is achieved by passing a heated gas through the bed of impregnated support as mentioned above, e.g. at 40 to 150° C., preferably about 80° C. Using such fluid bed apparatus for drying results in negligible particle breakdown even when prolonged drying periods are used.

Since such mechanical fluid bed mixers exert relatively low shear forces on the support material, mechanical disintegration of the support and hence generation of unwanted fines, is minimized. This and the uniformity of impregnation represents a significant improvement over the product produced using conventional stirred tanks.

If desired, support impregnation may be effected in a single operation or in a series of operations, optionally with drying being effected between impregnations. Typically, each impregnation step may be effected in 1 to 200 minutes, e.g. 15 to 100 minutes.

While mechanically fluidized bed mixers are commercially available, such mixers have not previously been modified to meet the particular requirements of catalyst impregnation onto particulate support material.

The supported catalysts may be used for polymer (e.g. polyolefin) production using standard polymerization techniques such as slurry phase and gas phase polymerizations and using standard polymerization reactors such as kettle reactors, loop reactors, gas phase reactors, etc.

If desired, a pre-polymerization of the supported catalyst particles may be effected before these are used in a polymerization reactor. This prepolymerization, e.g. with monomers such as C₂₋₁₀ α-olefins (such as ethene, propene, butene, hexene or 4-methylpentene) or other suitable monomers may even be effected within the mechanically fluidized fluid bed mixer used for preparation of the supported catalyst.

When compared with other mixing techniques for impregnation of a catalyst onto a particulate support, the use of a mechanically fluidized bed of the support material provides significant benefits. As compared with gas fluidized beds, a mixing effect is achieved which is not achieved with gas fluidized beds and solvent loss is reduced or eliminated. As compared with other mechanical mixing methods, the use of a mechanically fluidized bed gives a more even distribution of the catalyst material into the support particles and allows an optimum and essentially uniform loading to be achieved, ie. there is good inter and intra particle uniformity. As a result, the particulate polymer produced using the supported catalysts has particularly good morphology and improved homogeneity of crystallinity.

The process of the invention has a further advantage compared with the production of supported catalysts using conventionally stirred reactors. Thus a higher volume of impregnation solution can be used, corresponding to a slight overfilling of the pores of the support during impregnation. This can be achieved whilst still maintaining the support bed in a dry, free-flowing form. If pore overfilling is attempted in a conventionally stirred tank, this leads to catalyst agglomeration, ie. lump formation. Using the process of the invention with a volume of impregnation solution in excess of total pore volume improves the homogeneity of the catalyst and the properties of the resulting polymer. Typically the impregnation solution may be used in an amount corresponding to 101 to 120% of the pore volume of the non-impregnated support. During impregnation, some of the solvent (e.g. toluene) evaporates into the head space of the mixer apparatus and thus the total volume of the liquid actually impregnating the support may be adjusted to correspond to 100% of the pore volume. This use of “excess” impregnation solution improves the likelihood that all support particles are impregnated relative to standard “dry-mix” stirred tank impregnation procedures where use of greater than 100% pore volume quantities leads to agglomeration as mentioned above.

As compared with conventional dry mixing the process of the invention can achieve a very much higher degree of catalyst loading, in terms of the percentage of support particles that have detectable levels of catalyst loaded thereon.

Another method used for impregnation of polymerization catalysts into a particulate support is slurry mixing (slurry heterogenization). However this is disadvantageous relative to the process of stage (i) since it requires a much larger volume of catalyst impregnation solution to be used and so leads to undesired wastage of expensive raw materials. Furthermore the washing and filtering steps generally required for slurry mixing in order to avoid reactor fouling and ensure good polymer powder morphology and which generate further wastage are not required in the process of the invention.

This catatlyst may be used to polymerise conventional monomers or mixtures thereof especially ethylene and propene.

The polymer powder produced as described above is then treated as described in process steps (ii) to (iv) or (iia) to (iva).

The components A to D and optionally E may be mixed in any convenient vessel but are preferably mixed in a batch or continuous mixer to ensure excellent mixing occurs. Suitable mixing apparatuses include Forberg, Idecon, and Lodige mixers. The mixture of components is preferably in the liquid state at 100° C., e.g. molten or in solution, and is preferably sprayed onto the polymer powder at between 100° C. and 200° C. In this process it is preferred that the liquid stabilizer composition comprising components A to D and optionally E be heated to a temperature in the range 90 to 140° C., more preferably 100 to 130° C.

The polymer powder onto which the mixture is deposited, e.g. sprayed should preferably be at a temperature of between 20 to 80° C., e.g. 60° C. or 75° C. and should preferably be circulating in a mixer as spraying occurs. This ensures even distribution of the liquid stabilising solution over the polymer particles. The spraying may be direct, e.g. through a preheated spray die, or indirect, e.g. by directing a flow of liquid onto a diffuser. The mixture of components A to D and optionally E must be a liquid when spraying occurs.

The inert atmosphere may be provided by an conventional inert gas such as a noble gas or preferably nitrogen.

The UV-stabilizer or mixture of stabilisers used in the present invention should be compatible with the polymer, should have a relatively low melting point and/or good compatibility with the additive blend. Thus UV stabilisers which are soluble or partially soluble in the polymer (e.g. polyethylene) are preferred. It is also preferred if the UV-stabilisers are approved for use in polyolefins in contact with food. Preferred UV stabilisers are high molecular weight hindered amine light stabilisers, e.g. those having a molecular weight of 1500 to 4000, preferably 2000 to 3000.

Thus, suitable UV stabilisers therefore include [1,6-Hexanediamine, N,N′-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine] (e.g. Chimassorb 2020), Poly((6-morpholino-s-triazine-2,4-diyl) (2,2,6,6-tetramethyl-4-piperidyl)iminohexamethylene (2,2,6,6-tetramethyl-4-piperidyl)imino))] (e.g. Cyasorb UV 3346), Poly((6-((1,1,3,3-tetramethylbutyl)amino)-1,3,5-triazine-2,4-diyl) (2,2,6,6-tetramethyl-4-piperidyl)imino)-1,6-hexanediyl((2,2,6,6-tetramethyl-4-piperidyl)imino))] (e.g. Chimassorb 944), Cyasorb 4042 or Cyasorb 4611. Especially preferably the UV stabiliser is [1,6-Hexanediamine, N,N′-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine]. The structures of these stabilisers are illustrated in the scheme below.

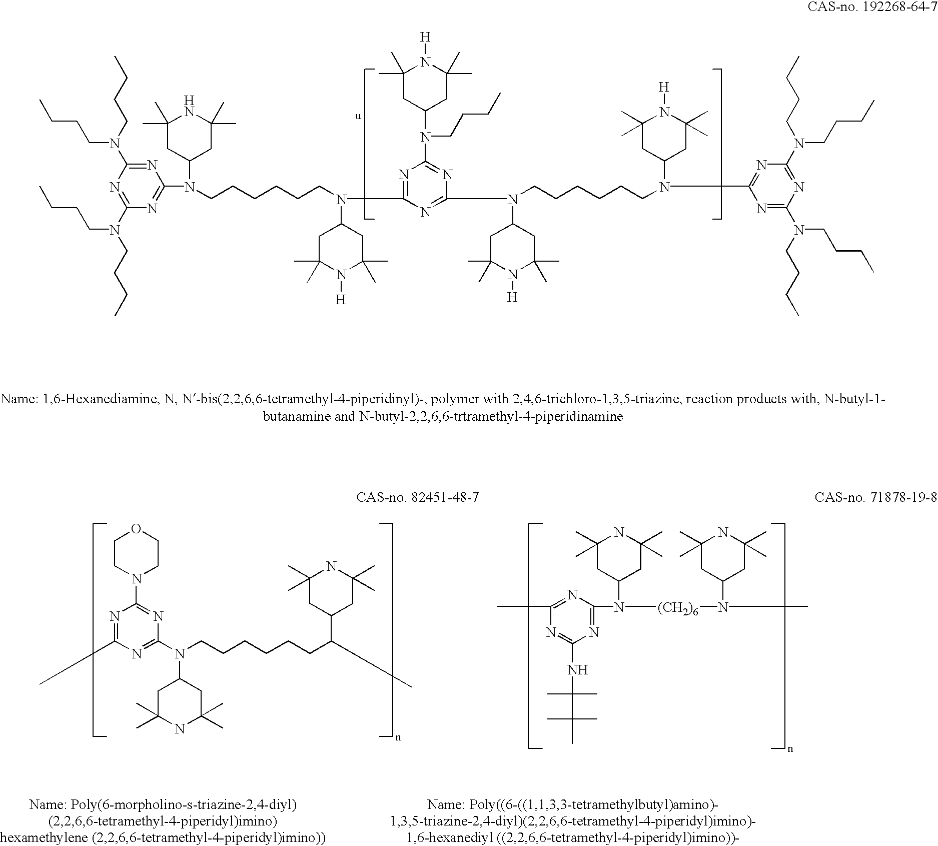

Chimassorb 2020 and Chimassorb 944 are available from Ciba Specialty Chemicals. Cyasorb 3346 is available from Cytec or from Everlight (Taiwan) where it is sold under the trade name Eversorb 92. Cyasorb 4042 and Cyasorb 4611 are available from Cytec.

Besides the UV-stabilizer, the polymer moulding powder used according to the invention has materials capable of inhibiting degradation of the polyolefin polymer, i.e. antioxidants and antacids.

The phenolic antioxidant should be approved for use in polyolefins in contact with food and is preferably [Octadecyl 3′-(3′,5′-di-tert.butyl-4-hydroxyphenyl)propionate] (e.g. Irganox 1076) or [Pentaerythrityl-tetrakis(3-(3′,5′-di-tert.butyl-4-hydroxyphenyl)-propionate] (e.g. Irganox 1010). It is also possible to employ a mixture of these compounds. Irganox 1010 and Irganox 1076 are available from Ciba Specialty Chemicals. Great Lakes Chemicals also sells these compounds where they are sold under the trade names Alkanox 20 and Alkanox 240 respectively. The phenolic antioxidant is most preferably [Octadecyl 3-(3′,5′-di-tert.butyl-4-hydroxyphenyl) propionate]. The structures of these compounds are illustrated below.

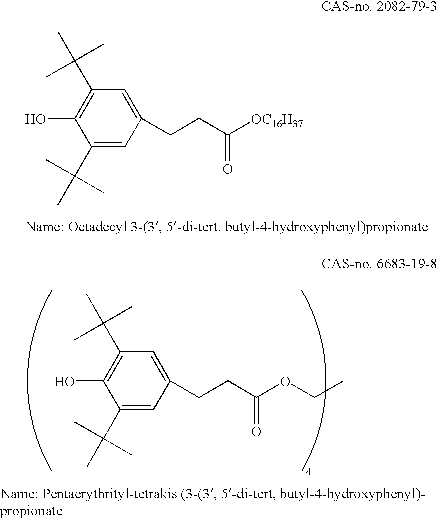

The organic phosphite or phosphonite antioxidant should be approved for use in polyolefins in contact with food and may be [Bis(2-methyl-4,6-bis(1,1-dimethylethyl)phenyl)phosphorous acid ethylester] (e.g. Irgafos 38), tris-nonylphenyl phosphite, [Tris (2,4-di-t-butylphenyl)phosphite] (e.g. Irgafos 168), [Tetrakis-(2,4-di-t-butylphenyl)-4,4′-biphenylen-di-phosphonite] (e.g. Irgafos P-EPQ) or [Phosphorous acid, cyclic butylethyl propandiol, 2,4,6-tri-t-butylphenyl ester] (e.g. Ultranox 641). The Irgafos range are available from Ciba Specialty Chemicals and Ultranox 641 is available from GE Specialty Chemicals. Tetrakis-(2,4-di-t-butylphenyl)-4,4′-biphenylen-di-phosphonite is also sold under the trade names Alkanox 24-44 by Great Lakes Chemicals and Sandostab P-EPQ by Clariant. Preferably the organic phosphite antioxidant is Bis(2-methyl-4,6-bis(1,1-dimethylethyl)phenyl)phosphorous acid ethylester. Structures of these compounds are illustrated below.

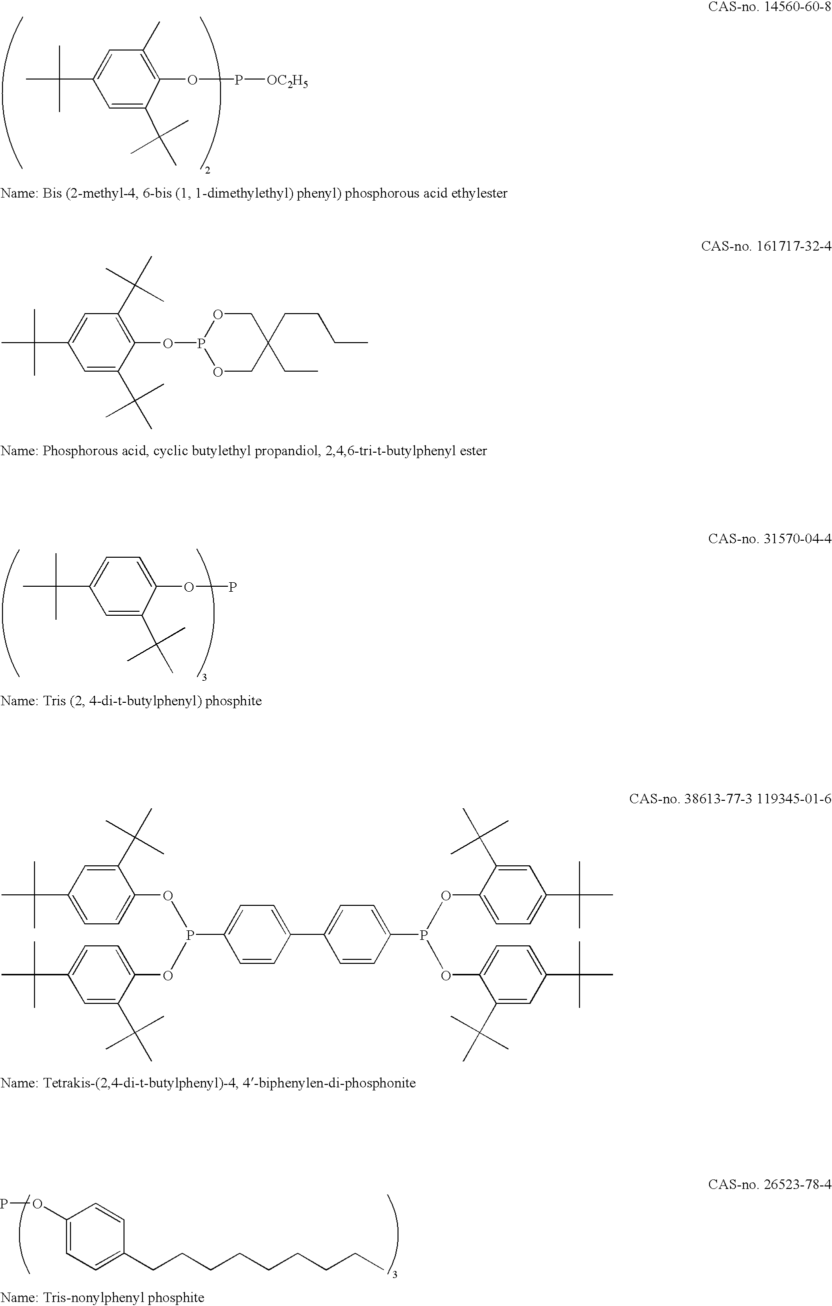

Examples of antacids include metal stearates, most preferably Zn-stearate or Ca-stearate. The stearate may be blended to the coated polymer particles as a fine powder or may be deposited onto the polymer powder as part of the additive mixture.

Suitable diluents are mineral oil, silicon oil, waxes e.g. polyethylene wax, epoxidised soybean oil, antistatic agents, glyceryl monocarboxylic ester, and N,N-bis(2-hydroxyethyl) dodecanamide. Especially preferably the diluent is mineral oil or N,N-bis(2-hydroxyethyl)dodecanamide. N,N-bis(2-hydroxyethyl)dodecanamide is believed to act not only as a diluent but also as an antistatic agent which may be beneficial for rotomoulding and in rotomoulded articles. The use of N,N-bis(2-hydroxyethyl)dodecanamide may also improve surface finish.

The polymer moulding powder should preferably comprise 0.01 to 0.5 wt %, e.g. 0.1 to 0.2 wt % organic phosphite or phosphonite antioxidant, 0.01 to 0.5 wt %, e.g. 0.1 to 0.3 wt % phenolic antioxidant, 0.01 to 2 wt %, e.g. 0.1 to 1 wt % UV stabiliser, 0.01 to 0.05 wt %, e.g. 0.1 to 0.3 wt % metal stearate and 0.02 to 3 wt %, e.g. 0.1 to 1 wt % diluent.

Besides the stabilizer(s), the moulding powder may contain with other additives, e.g. lubricants, anti-fogging agents, antistatic agents, clarifiers, nucleating agents, blowing agents, plasticizers, flame retardants, etc. Where the rotomoulded items made using the moulded polymer powder are for use in the food industry preferably all the ingredients in the rotomoulding powder will be of a grade approved for food contact purposes.

Rotational moulding using the moulding powder of the invention may be effected conventionally, e.g. using commercially available rotomoulding apparatus. The oven temperature and oven curing time may be selected according to the melting characteristics of the polymer and the thickness of the item being produced.

The polymer moulding powder of the invention may be employed as the sole polymer rotomoulding component or may be combined with other polymers.

The moulding powder used according to the invention preferably has a mean polymer particle size (e.g. as determinied using a particle size analyser such as a Malvern analyzer) of 1 to 2000 μm, preferably SO to 1000 μm, especially 100 to 500 μm. The particle size distribution is preferably such that:

D(v, 0.5) is between 100 and 500 μm

D(v, 0.1) is between 50 and 300 μm

D(v, 0.9) is between 300 and 1000 μm

most preferably D(v, 0.5) being between

200 and 400 μm, D(v, 0.1) being between

100 and 200 μm, and D(v, 0.9) being between

400 and 600 μm.

(D(v, 0.5) means the particle diameter below which 50% by volume of the particles fall; similarly D(v, 0.1) is the particle diameter below which 10% by volume of the particles fall). This choice of particle size and uniformity ensures uniformity in the resulting rotationally moulded product.

For different polyolefin polymers, the optimum particle sizes will differ slightly. However, by way of example for polyethylenes with MFR₂ 1 to 40 and densities 920 to 950 kg/M³, the optimum particle size will generally be 100 to 600 μm. Where the particle size is too large, the melting characteristics in rotational moulding will be poor leading to mechanically sub-standard moulded products. On the other hand, where the particle size is too small the powder will have poor flow characteristics and will not distribute evenly in the mould.

The particle sizes and particle size distributions for the UV-stabilizer-loaded and unloaded particulates which may make up the moulding powder are preferably closely similar although a difference in mean particle size of up to 20% or more preferably up to 10% for the two sets of particles is tolerable. Such similarity in size ensures that unwanted separation of loaded and unloaded particles in the moulding powder does not occur during storage or transportation.

The UV-stabilizer-loaded particulates are preferably formed of the same or a similar polymer to the unloaded polyolefin particles. Some variation in polymer type is tolerable but generally the predominant monomer should be the same for both particulates. This ensures that the moulding powder melts substantially uniformly during the moulding process.

The polymers used will preferably have a narrow molecular weight distribution Mw/Mn to ensure a relatively sharp melting point and hence even distribution in the mould. Mw/Mn values preferably lie in the range 2 to 10, more especially 2 to 5. Preferably the polymers should have a melting point of 100 to 180° C., more preferably 120 to 130° C., with a melting range of less than 20° C.

The non-UV-stabilizer-loaded polyolefin polymer particulate preferably has a very homogeneous molecular structure, seen as a narrow melting range in the curve obtained by differential scanning calorimetry and as a very even crystal structure in micrographic studies. This ensures that the powder melts evenly and that the homogeneity of the moulded product is high.

To ensure that the moulds used in rotational moulding may be loaded with sufficient polymer to produce moulded items with adequate wall thicknesses, it is also desirable that the moulding powder should have a bulk density of at least 300 kg/m³ more preferably at least 330 kg/m³, e.g. 330 to 500 kg/M³, more particularly 450 to 490 kg/M³.

The polymer density is conveniently in the range 800 to 1000 kg/m³, particularly 850 to 950 kg/M³. For polyethylene, the density is preferably 920 to 950 kg/m³, more preferably 930 to 940 kg/m³. For polypropylenes, the density is preferably 880 to 950 kg/m³, more preferably 890 to 910 kg/M³.

The polymer preferably has a melt flow rate MFR₂ of 1 to 30 g/10 min., more preferably 2 to 20 g/10 min. For polyethylenes, the MFR₂ is preferably 2 to 10 g/10 min., more preferably 3 to 7.5 g/10 min. For polypropylenes, the MFR₂ is preferably 10 to 20 g/10 min., more preferably 12 to 18 g/10 min.

The polymer moulding powder preferably has a dry flow of 10 to 40 s/100 g, more preferably 15 to 30 s/100 g.

The polymer which is loaded with the UV-stabilizer may be produced by similar techniques or by other conventional polymerization techniques.

The UV-stabilizer used in stage (iia) to (iva) may be any organic molecule UV-stabilizer, e.g. a UV absorber, e.g. a benzophenone, benzotriazole, a hindered amine light stabilizer (a HALS)for example a hindered cyclic amine, or a polymeric amine, in particular hindered polymeric amines, e.g. compounds containing one or more azacyclohexyl groups and more particularly 2,2,6,6-tetramethyl-1-azacyclohexyl or 1,2,2,6,6-pentamethyl-1-azacyclohezyl residues, for example in the polymer repeat units. Examples of suitable UV-stabilizers include Tinuvin 622, Tinuvin 326, Tinuvin 327, Tinuvin 770, Chimasorb 81, Chimasorb 944, Cyasorb UV-3346, Hostavin N30, Hostavin N20, Dastib 845, ADK STAB LA63, ADK STAB LA68LD, ADK STAB LA57, ADK STAB LA67, Uvinyl 4050H, CGL 2020, CGL 116, UV Check AM 806, Uvasorb HA88, N,N′-bis(2,2,6,6-tetramethyl-4-piperidyl)-N,N′-hexamethylenebis(formamide), N-(2,2,6,6-tetramethyl-4-piperidyl)-maleinimide, CAS No. 1843-05-06, CAS No. 3864-99-1, CAS No. 3896-11-5, CAS No. 52829-07-9, CAS No. 41556-26-7, CAS No. 82919-37-7, CAS No. 86403-32-9, CAS No. 604022-61-3, CAS No. 91788-83-9, CAS No. 102089-33-8, CAS No. 73704-27-5, CAS No. 136504-96-6, CAS No. 193098-40-7, CAS No. 82451-48-7, CAS No. 101544-98-3, CAS No. 84696-70-0, CAS No. 81406-61-3, CAS No. 94274-03-0, CAS No. 65447-77-0, CAS No. 71878-19-8 and CAS No. 106990-43-6.

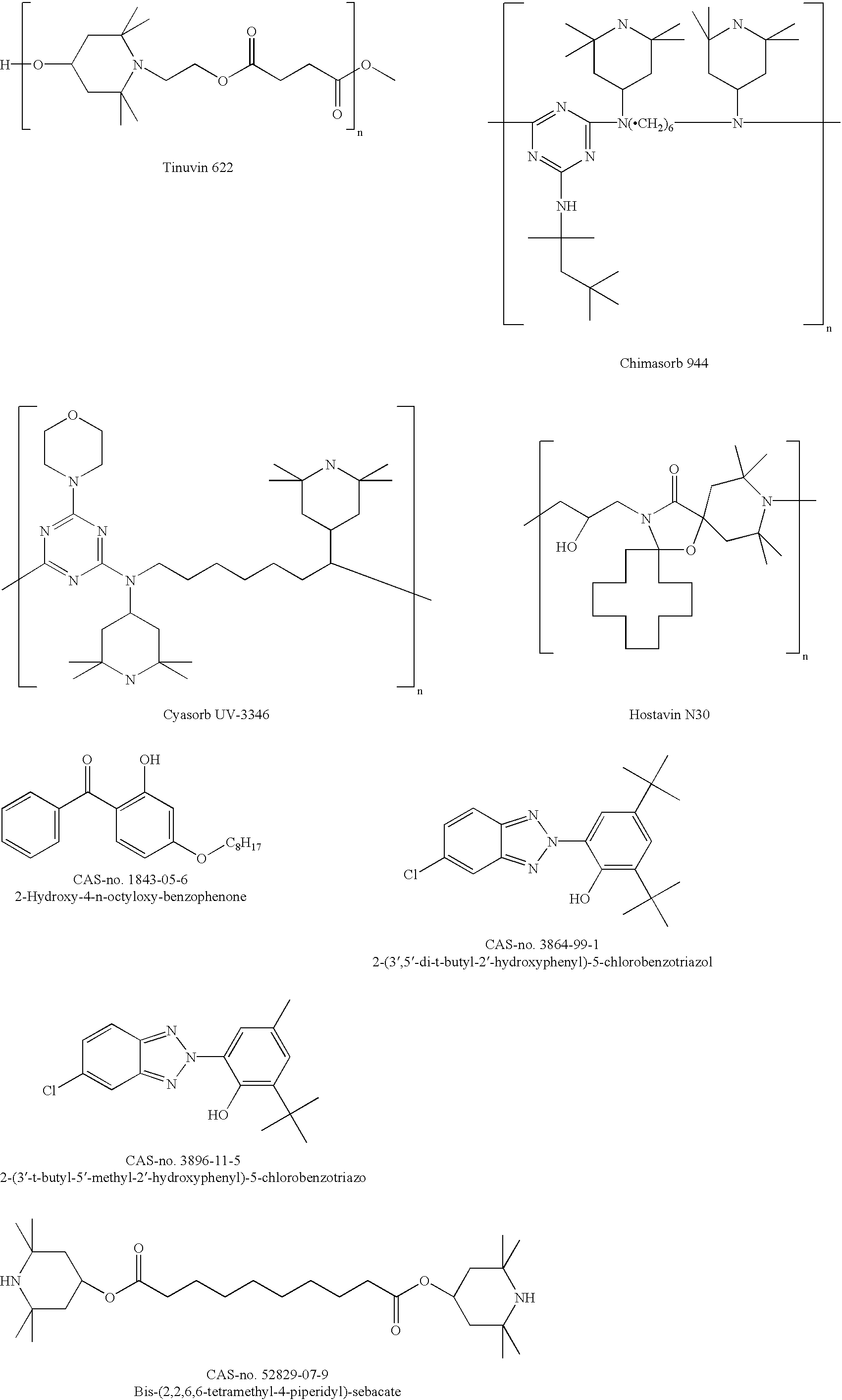

The UV-stabilizer conveniently has a melting point/softening point in the range 20 to 200° C., more particularly 55 to 150° C., or is in a liquid form at ambient temperature. Typically, the stabilizer may have a (weight average) molecular weight in the range 300 to 5000, more generally 500 to 3000.

Besides the UV-stabilizer, the moulding powder formed by route (iia)-(iva) may, and indeed generally will, contain other stabilizers and additives.

The other stabilizers used according to the invention may be any materials capable of inhibiting degradation of the polyolefin polymer. Appropriate stabilizer materials include antioxidants, antiacids and thermal stabilizers.

Examples of antioxidants include phenols, phosphites, phosphonites, thioesters and thioethers, e.g. trinonylphenylphosphite. Examples of antiacids include stearates (e.g. Zn-stearate), carbonates, and hydrotalcite.

Particularly preferably, the UV-stabilizer-loaded polymer particles will be loaded with more than one stabilizer material, preferably at least one antioxidant and at least one UV-stabilizer.

Besides the stabilizer(s), the moulding powder may contain with other additives, e.g. lubricants, anti-fogging agents, plasticizers, flame retardants, etc.

The loading of the polymer particles with UV-stabilizers (and optionally other additives) is conveniently effected by extrusion (e.g. from a high shear mixer) and granulation and subsequent grinding of the solidified product. It is desirable that the UV-stabilizer be distributed throughout the stabilizer loaded particles.

Desirably the UV-stabilizer, a particulate polymer and any further additives (e.g. antioxidants) to be included in the masterbatch particulate are blended in a mechanical mixer (e.g. a Forberg blender) before being introduced into an extruder (e.g. a Brabander extruder 19/25). The extrudate is then ground and sieved to select a particulate of the desired particle size range.

The remaining components of the moulding powder, if any, can be added when the masterbatch and the non-loaded polyolefin particles are mixed together. Liquid or low melting components may be sprayed onto the particulate mixture and solid components may be mixed in in particulate form, preferably powder form.

Thus in a preferred embodiment a stabilizer (or stabilizer plus additives mixture) is sprayed onto a mixture of UV-stabilizer-loaded and non-loaded polymer particles in a mixer chamber, e.g. the mixing chamber of a mechanically fluidized bed mixer (for example a Forberg mixer). It is preferred that both the liquid being sprayed and the polymer particles are heated, e.g. to 40 to 150° C., preferably 60 to 110° C. Stabilizers and additives may be added to the polymer together or sequentially. If powdered additives or stabilizers are added however it is preferred that their particle sizes be comparable to or smaller than that of the polymer.

In this process it is preferred that the liquid stabilizer composition be heated to a temperature in the range 90 to 140° C., more preferably 100 to 130° C., and that the polymer, before spraying commences, be heated to a temperature in the range 60 to 80° C. The spraying may be direct, e.g. through a preheated spray die, or indirect, e.g. by directing a flow of liquid onto a diffuser.

In the moulding powder, the polymer particles will desirably contain UV-stabilizer loaded polymer particles and non-loaded polyolefin polymer particles in a weight ratio of from 0.5:99.5 to 1:10, more preferably 1:99 to 5:95, still more preferably 2:98 to 4:96.

The UV-stabilizer loaded particles (the masterbatch) will preferably contain 3 to 20%, more preferably 5 to 15%, still more preferably 8 to 12% by weight of the UV-stabilizer. The precise level of UV-stabilizer loading clearly affects the amount of masterbatch added in the moulding powder. For a 10% UV-stabilizer masterbatch it will generally be possible to use a 25:975 (w/w) masterbatch to non-loaded polymer ratio, meaning that only 25 g of each kg of polymer needs to be extruded and ground.

The moulding powder will preferably contain other stabilizers and additives at conventional concentrations, e.g. at individual concentrations in the 100 to 5000 μppm range.

Rotational moulding using the moulding powder of the invention may be effected conventionally, e.g. using commercially available rotomoulding apparatus. The oven temperature and oven curing time may be selected according to the melting characteristics of the polymer and the thickness of the item being produced.

The invention is illustrated further by the following non-limiting Examples.

### EXAMPLE 1

Preparation of Support Material

Sylopol 2109, a silica from Grace Davison was calcined at 600° C. for 4 hours in dry air.

### EXAMPLE 2

Impregnation of Support Material

In a dry box, 0.72 g (1.78 mmol) of (nBuCp)₂ ZrCl₂ (Eurocene 5031 from Witco) was dissolved in 77.35 mL of MAO solution (30 wt % MAO in toluene solution, 365 mmol Al, available from Albermarle SA). 39.65 mL toluene (distilled from sodium) was added and the mixture was stirred in the dark at ambient temperature for 30 minutes.

65 g of Sylopol 2109 from Example 1 was placed in a bench scale 0.25L mechanically fluidized bed mixer of the Forberg type in the dry box. 117 mL of the MAO/metallocene solution was added onto the fluidized silica over 3 minutes using a syringe and a spray nozzle to ensure optimum distribution. This corresponded to 1.8 mL solution per gram silica. The impregnated support material was calculated to have an Al:Zr molar ratio of 200, an aluminium content of 11.0 wt % and a Zr content of 0.18 wt %.

Samples of the impregnated support were dried using four different procedures:

A. The supported catalyst was dried for 30 minutes by passing N₂ (preheated to 40° C.) at a rate of 230 L/h through the catalyst while still running the mechanically fluidized bed mixer. This gave a final toluene content of about 2 wt %.

B. Drying was first effected as in procedure A. Then nitrogen (preheated to 70° C.) was passed through the catalyst for a further 6 hours at a nitrogen flow rate of 350 L/h. The toluene content of the product was less than 0.5 wt %.

C. The catalyst was withdrawn from the mixer and dried on a hot plate for 1 hour at 40-50° C. using a nitrogen purge.

D. The catalyst was withdrawn from the mixer and dried on a hot plate for 1 hour at 40-50° C. using a nitrogen purge and at a pressure of 0.7 bar below ambient.

Procedure B gave the most satisfactory result.

### EXAMPLE 3

Ethylene:Hexene Copolymerization

Using the catalyst of Example 2 (dried by procedure B), ethylene was polymerized in a slurry phase reactor.

An 8L stainless steel reactor equipped with a flash tank was charged with isobutane (3.8L). 635 mg catalyst was added via an inert tube. Hydrogen (440 ppm) premixed in ethene and 1.40 wt % (relative to ethene) of hex-1-ene were introduced via cascaded addition. The reactor temperature was 94° C. and the reactor pressure was 25.5 bar. The total run time was 45 minutes. After the polymerization reaction, the ethylene hexene copolymer (PEH) was dried in the flash tank for 1 hour with a nitrogen purge. 1829 g polymer (PEH) was produced in one run and 1980 g in another using the same conditions.

Catalyst activity was 3870 kg PEH/g catalyst/hour on run 1 and 4090 kg/g/hr in run 2; the polymer average particle size was 238 μm in run 1, the bulk density 0.44 kg/L for both runs, and the MFR₂ 5.5 and 5.2 on runs 1 and 2 respectively. The polymer powder as produced had excellent homogeneity, and is suitable, for example, for rotomoulding.

### EXAMPLE 4

Masterbatch preparation

| | | |
|---|---|---|
| Chimasorb 944* | 10 | parts by weight |
| (UV stabilizer) | | |
| Irgafos 168* | 1200 | ppm |
| (antioxidant) | | |
| Polyethylene powder | to 100 | parts by weight |

*Available from Ciba Speciality Chemicals

Polyethylene powder (bulk density 460 to 480 kg/M³, MFR₂ 5.9 to 6.8 g/10 min., and particle size distribution: 600 μm max. 0%, 500 μm max 5%, 425 μm max 5-30%, 300 μm max 20-40%, 212 μm max 15-35%, 150 μm max 8-20%, <150 μm max 10%) obtained from Example 3 was blended in a Forberg mixer for six minutes with the Chimasorb and Irgafos stabilizers. The blend was pelletized on a Brabander extruder 19/25 (temperature profile 180° C.-200° C.-200° C.-200° C., screw rate 120 rpm). The pellets were ground in a mill and sieved on a 400 μm sieve to produce the masterbatch.

### EXAMPLE 5

Moulding powder

| | | |
|---|---|---|
| Masterbatch | 2.5 | parts/wt |
| (from Example 4) | | |
| Irganox 1010* | 600 | ppm |
| (antioxidant) | | |
| Irgafos 38* | 1200 | ppm |
| (antioxidant) | | |
| Zn-stearate* | 1800 | ppm |
| Ondina 941 mineral oil | 500 | ppm |
| (diluent) | | |
| Polyethylene powder | to 100 | parts by weight |
| (as in Example 4) | | |

*Available from Ciba Speciality Chemicals
⁺Available as Zincum AV from Barlocher

The antioxidants were heated to 100-130° C. together with the mineral oil. The polyethylene powder was heated to 70° C. and then transferred to a Forberg mixer. Zn-stearate powder and masterbatch were added and the mixture was blended for 2 to 3 minutes. The hot antioxidants were sprayed onto the mixture through a pre-heated die while mixing continued. Blending was stopped 6 minutes after spraying was completed.

### EXAMPLE 6

Rotational Moulding

The moulding powder of Example 7 was moulded with polyethylene items using a Rotospeed E-60 Express rotomoulding machine. There was no deposit of UV-stabilizer on the mould (FT-IR analysis) and the moulded products had satisfactory impact strength and UV stability.

The rotomoulding machine was a shuttle machine with one cranked arm provided with a 44 kW propane gas burner, a 10000 CFM (283 m³/min) circulating fan, a 750 CFM (21 m³/min) exhaust fan, and two 3350 CFM (95 m³/min) forced air cooling fans. The oven temperature used was 280° C. with an oven time of 10 minutes and a cooling time of 20 minutes.

The mould used was an alumina box mould of approximately 3 liter volume. The rotation ratio was 9:1.4 and the rotational rates were 9/mm and 1.4/min. The moulding powder load was 2.5 kg giving a wall thickness of approximately 4 mm.

### EXAMPLE 7

| | | |
|---|---|---|
| PE powder from Example 3 | ≈10 | kg (to 100 wt %) |
| Irganox 1076 | 6 | g |
| Irgafos 38 | 12 | g |
| Chimassorb 2020 | 17 | g |
| Ondina 941 white mineral oil | 38 | g |
| Zinc Stearate | 18 | g |

Irganox 1076 (6 g), Irgafos 38 (12 g), Chimassorb 2020 (17 g) together with Ondina 941 mineral oil (38 g available from the Shell Oil Company) were heated to 100-130° C. under a nitrogen atmosphere. In a mechanically fluidised bed mixer, e.g. a Forberg mixer, the hot additives were sprayed onto a circulating polyethylene powder prepared as described in Example 1, the powder having a temperature of 60° C. Zinc Stearate powder was added and the mixture blended for another five minutes.

### EXAMPLE 8

Rotational Moulding

The moulding powder of Example 7 was moulded with polyethylene items using a Rotospeed E-60 Express rotomoulding machine. There was no deposit of UV-stabilizer on the mould (visual inspection and FT-IR analysis) and the moulded products had satisfactory impact strength and UV stability.

The rotomoulding machine was a shuttle machine with one cranked arm provided with a 44 kW propane gas burner, a 10000 CFM (283 m³/min) circulating fan, a 750 CFM (21 m³/min) exhaust fan, and two 3350 CFM (95 m³/min) forced air cooling fans. The oven temperature used was 270° C. with an oven time of 14 minutes and a cooling time of 20 minutes.

The mould used was an alumina box mould of approximately 200 mm×200 mm×200 mm dimensions. The rotation ratio was 9:1.4 and the rotational rates were 9/mm and 1.4/min. The moulding powder load was 0.7 kg giving a wall thickness of approximately 4 mm.

### EXAMPLE 9

The rotomoulded box from Example 8 was analysed.

Homogeneous Morphology was found to be excellent. Falling Weight Impact Properties were measured at −20° C.: Force (N/mm) 1470; Energy (J/mm) 19; Type of Failure: Ductile.

### Example 10

Influence of UV Stabiliser on Properties of Rotomoulded Article.

| | |
|---|---|
| PE powder from Example 3 | 10 kg (to 100 wt %) |
| Irganox 1076 | 6 g—(600 ppm) |
| Irgafos 38 | 12 g—(1200 ppm) |
| UV stabiliser | 20 g—(2000 ppm) |
| Ondina 941 white mineral oil | 47 g—(4700 ppm) |

Irganox 1076, Irgafos 38, UV stabiliser, Zn-stearate together with Ondina 941 mineral oil were heated to 120-140° C. under a nitrogen atmosphere. In a mechanically fluidised bed mixer, e.g. a Forberg mixer, the hot additives were sprayed onto a circulating polyethylene powder prepared as described in Example 3, the powder having a temperature of 60° C. Zinc stearate powder (9 g) was added and the mixture blended for another five minutes. The mixture was blended for another five minutes. Rotomoulding was effected as described in Example 8.

The yellowness index of the resulting articles was measured. Percentage retained mechanical properties after 3000 hours in wheather-o-meter C165 were measured according to ISO 4892.

| UV stabiliser | YI₀ | Elongation to break, ISO 527-5A |
|---|---|---|
| Chimassorb 2020 | −6.5 | 65% retained mechanical properties after |
| | | 3000 hours in WOM |
| Cyasorb 3364 | −6.8 | 70% retained mechanical properties after |
| | | 3000 hours in WOM |
| Cyasorb 4042 | −6.4 | |
| Cyasorb 4611 | −5.2 | |

### Example 11

Influence of Phosphites/Phosphonites on Properties of Rotationally Moulded Article.

| | |
|---|---|
| PE powder from Example 3 | 10 kg (to 100 wt %) |
| Irganox 1076 | 6 g—(600 ppm) |
| Phosphite | 12 g—(1200 ppm) |
| Chimassorb 2020 | 20 g—(2000 ppm) |
| Ondina 941 white mineral oil | 47 g—(4700 ppm) |
| Zinc Stearate | 9 g—(900 ppm) |

Rotomoulded articles were prepared following the experimental procedure described in Example 10.

The yellowness index of the resulting articles was measured.

| Phosphite | YI₀ |
|---|---|
| Irgafos 38 | −6.5 |
| Irgafos P-EPQ | −7.7 |
| Ultranox 641 | −7.8 |

The YI values for the rotomoulded articles made in Examples 10 and 11 are lower than those associated with conventional rotomoulded articles. The mechanical property values determined are comparable with conventional rotomoulded articles showing that the process of the invention does not detrimentally affect mechanical properties.

1. A process for the preparation of a polymer moulding powder comprising
(i) impregnating a mechanically fluidized porous particulate support material with a catalyst and polymerizing a monomer or monomer mixture in the presence of the catalyst-impregnated support material to give olefin polymer particles; and then either
(ii) heating a mixture of:
A) at least one phenolic antioxidant;
B) at least one organic phosphite or phosphonite antioxidant;
C) at least one UV-stabiliser;
D) a diluent; and optionally
E) a metal stearate;
to a temperature of between 20 and 200° C.;
(iii) depositing the mixture onto said polyolefin polymer particles; and optionally
(iv) blending a metal stearate to the resulting polyolefin polymer particles if component E was not present in said mixture; or
(iia) obtaining a second polymer; (iiia) intimately mixing said second polymer with a UV-stabilizer to produce a plurality of UV-stabilizer loaded polymer particles, e.g. by admixing stabilizer and particles of said second polymer followed by melting and grinding the resultant admixture; (iva) admixing polymer particles obtained in step (i) with UV-stabilizer-loaded polymer particles obtained in step (iiia).

2. A process as claimed in claim 1 wherein said at least one phenolic antioxidant is selected from [Octadecyl 3-(3′,5′-di-tert.butyl-4-hydroxyphenyl)propionate] (e.g. Irganox 1076) or [Pentaerythrityl-tetrakis(3-(3′,5′-di-tert.butyl-4-hydroxyphenyl)-propionate] (e.g. Irganox 1010).

3. A process as claimed in claim 1 or 2 wherein said at least one organic phosphite or phosphonite antioxidant is selected from [Bis(2-methyl-4,6-bis(1,1-dimethylethyl)phenyl)phosphorous acid ethylester] (e.g. Irgafos 38), [Tris(2,4-di-t-butylphenyl)phosphite] (e.g. Irgafos 168), tris-nonylphenyl phosphate, [Tetrakis-(2,4-di-t-butylphenyl)-4,4′-biphenylen-di-phosphonite] (e.g. Irgafos P-EPQ) or [Phosphorous acid-cyclic butylethyl propandiol, 2,4,6-tri-t-butylphenyl ester] (e.g. Ultranox 641).

4. A process as claimed in any one of claims 1 to 3 wherein said olefin polymer particles are polyethylene or polypropylene homo or copolymer particles.

5. A process as claimed in any one of claims 1 to 4 wherein in step (ii)(C) said UV stabiliser is selected from [1,6-Hexanediamine, N,N′-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine] (e.g. Chimassorb 2020), [Poly((6-morpholino-s-triazine-2,4-diyl)(2,2,6,6-tetramethyl-4-piperidyl)imino) hexamethylene (2,2,6,6-tetramethyl-4-piperidyl)imino))] (e.g. Cyasorb UV 3346) or [Poly((6-((1,1,3,3-tetramethylbutyl)amino)-1,3,5-triazine-2,4-diyl)(2,2,6,6-tetramethyl-4-piperidyl)imino)-1,6-hexanediyl((2,2,6,6-tetramethyl-4-piperidyl)imino))] (e.g. Chimassorb 944); Cyasorb 4042 or Cyasorb 4611.

6. A process as claimed in claim 5 wherein said UV stabiliser is [1,6-Hexanediamine, N,N′-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine].

7. A process as claimed in any one of claims 1 to 6 wherein said phenolic antioxidant is [Octadecyl 3-(3′,5′-di-tert.butyl-4-hydroxyphenyl)propionate].

8. A process as claimed in any one of claims 1 to 7 wherein said at least one organic phosphite or phosphonite antioxidant is [Bis(2-methyl-4,6-bis(1,1-dimethylethyl)phenyl)phosphorous acid ethylester].

9. A process as claimed in any one of claims 1 to 8 wherein said metal stearate is zinc stearate.

10. A process as claimed in any one of claims 1 to 9 wherein said diluent is selected from mineral oil, silicon oil, waxes e.g. polyethylene wax, epoxidised soybean oil, antistatic agents, glyceryl monocarboxylic ester, and N,N-bis(2-hydroxyethyl)dodecanamide.

11. A process as claimed in any one of claims 1 to 10 wherein said mixture comprises 0.01 to 0.5 wt % organic phosphite or phosphonite antioxidant, 0.01 to 0.05 wt %, phenolic antioxidant, 0.01 to 2 wt % UV stabiliser, 0.01 to 0.5 wt %, metal stearate and 0.02 to 3 wt %, diluent.

12. A process as claimed in any one of claims 1 to 11 wherein all the components of said mixture are approved for contact with food.

13. A process as claimed in claim 1 wherein said second polymer is obtained by the process described in step (i).

14. A process as claimed in claim 1 or 13 wherein said second polymer has a mean particle size of 100 to 500 μm.

15. A process as claimed in claim 1, 13 or 14 wherein said second polymer has a bulk density of 300 to 500 kg/m³.

16. A process as claimed in claim 1 or 13 to 15 in wherein in step (iiia) said UV-stabiliser is a hindered polymeric amine containing at least one azacyclohexyl group.

17. A process as claimed in claim 1 or 13 to 16 wherein said UV-stabiliser loaded and UV-stabiliser unloaded particles are present in a weight ratio of from 0.5:99.5 to 1:10.

18. A process as claimed in claim 1 or 13 to 17 wherein asid UV-stabiliser loaded particles contain 5 to 15% wt of UV stabiliser.

19. A process as claimed in any preceding claim wherein said olefin polymer particles have a mean particle size of 1 to 2000 μm.

20. A process as claimed in any preceding claim wherein said olefin polymer particles have a mean particle size of 100 to 500 μm.

21. A process as claimed in any preceding claim wherein said porous support is an inorganic oxide or halide or an organic polymer.

22. A process as claimed in any preceding claim wherein said porous support is an inorganic material and is subjected to heat treatment before impregnation with said catalytic material.

23. A process as claimed in any preceding claim wherein said support is impregnated with said catalyst material in a mixer having horizontal axis counter-rotating interlocking mixing paddles.

24. A process as claimed in any preceding claim wherein said support is impregnated with said catalyst material in a mixer having a Froude number of from 1.05 to 2.2.

25. A process as claimed in any preceding claim wherein a solution of said catalyst material is sprayed onto said support.

26. A process as claimed in claim 25 wherein the volume of said solution sprayed onto said support is from 0.8 to 2.0 times the pore volume of said support.

27. A process as claimed in any preceding claim wherein said catalyst material is selected from metallocenes, aluminoxanes and mixtures of two or more thereof.

28. A process as claimed in any preceding claim wherein after the impregnation of said support with said catalyst material, said support is dried.

29. A process as claimed in claim 28 wherein drying is effected sufficiently to achieve a residual solvent content of less than 3 wt %.

30. A process as claimed in claim 26 wherein said support is impregnated with a solution of said catalyst material in an organic solvent and wherein drying is effected sufficiently to achieve a residual solvent content of less than 1.5 wt %.

31. A process as claimed in claim 30 wherein drying is effected sufficiently to achieve a residual solvent content of less than 1 wt %.

32. A polymer moulding powder for rotational moulding obtainable by a process as described in any one of claims 1 to 31.

33. A process for the preparation of a moulded polymer item, said process comprising rotomoulding a polymer moulding powder as described in any one of claims 1 to 31.

34. A moulded polymer item obtainable by a process in which a polymer moulding powder as claimed in claim 32 is rotomoulded.
